(19) United States
(12) Patent Application Publication
(10) Pub. No.: US 2014/0187331 A1
(43) Pub. Date: Jul. 3, 2014

(54) LATENCY REDUCTION BY SUB-FRAME ENCODING AND TRANSMISSION

(71) Applicant: NVIDIA CORPORATION, Santa Clara, CA (US)

(72) Inventors: Taekhyun Kim, Sung-nam (KR); Swagat Mohapatra, Pune (IN); Mukta Gore, Santa Clara, CA (US); Alok Ahuja, Santa Clara, CA (US)

(73) Assignee: NVIDIA CORPORATION, Santa Clara, CA (US)

(21) Appl. No.: 13/728,296

(22) Filed: Dec. 27, 2012

(51) Int. Cl. A63F 13/12; H04N 7/26

(52) U.S. Cl. CPC A63F 13/12; H04N 7/26005
USPC 463/42; 375/240.01; 375/240.02; 375/240.07

(57) ABSTRACT

A cloud gaming system includes a cloud gaming server that provides rendering for a video frame employed in cloud gaming. The cloud gaming system also includes a video frame latency reduction pipeline coupled to the cloud gaming server, having a slice generator that provides a set of separately-rendered video frame slices required for a video frame, a slice encoder that encodes each of the set of separately-rendered video frame slices into corresponding separately-encoded video frame slices of the video frame and a slice packetizer that packages each separately-encoded video frame slice into slice transmission packets. The cloud gaming system further includes a cloud network that transmits the slice transmission packets and a cloud gaming client that processes the slice transmission packets to construct the video frame. A video frame latency reduction method is also provided.

### TECHNICAL FIELD

This application is directed, in general, to cloud video gaming and, more specifically, to a video frame latency reduction pipeline, a video frame latency reduction method and a cloud gaming system.

### BACKGROUND

In the arena of cloud gaming, a cloud server typically provides video rendering of the game for a gaming display device thereby allowing a user of the device to play the game. The cloud server creates each video frame required to play the game, compresses the entire frame through video encoding and transmits a bitstream of packets corresponding to the entire frame over associated transmission networks to the display device. In this process, the video encoding portion currently delays the start of video frame transmission until the video frame is fully encoded. This delay often introduces viewer display latencies that reduce the gaming experience. Additionally, transmission of the entire video frame may occasionally exceed available burst transmission bandwidths resulting in lost transmission packets and reduced video frame quality, which also degrades the gaming experience.

### SUMMARY

Embodiments of the present disclosure provide a video frame latency reduction pipeline, a video frame latency reduction method and a cloud gaming system.

In one embodiment, the video frame latency reduction pipeline includes a slice generator configured to provide a rendered video frame slice required for a video frame and a slice encoder configured to encode the rendered video frame slice of the video frame. Additionally, the video frame latency reduction pipeline also includes a slice packetizer configured to package the encoded and rendered video frame slice into packets for transmission.

In another aspect, the video frame latency reduction method includes providing a set of rendered video frame slices required to complete a video frame and encoding each of the set of rendered video frame slices. The video frame latency reduction method also includes transmitting video frame slice packets corresponding to each of the set of rendered video frame slices and constructing the video frame from the video frame slice packets.

In yet another aspect, the cloud gaming system includes a cloud gaming server that provides rendering for a video frame employed in cloud gaming. The cloud gaming system also includes a video frame latency reduction pipeline coupled to the cloud gaming server, having a slice generator that provides a set of separately-rendered video frame slices required for a video frame, a slice encoder that encodes each of the set of separately-rendered video frame slices into corresponding separately-encoded video frame slices of the video frame and a slice packetizer that packages each separately-encoded video frame slice into slice transmission packets. The cloud gaming system further includes a cloud network that transmits the slice transmission packets and a cloud gaming client that processes the slice transmission packets to construct the video frame.

The foregoing has outlined preferred and alternative features of the present disclosure so that those skilled in the art may better understand the detailed description of the disclosure that follows. Additional features of the disclosure will be described hereinafter that form the subject of the claims of the disclosure. Those skilled in the art will appreciate that they can readily use the disclosed conception and specific embodiment as a basis for designing or modifying other structures for carrying out the same purposes of the present disclosure.

### BRIEF DESCRIPTION

Reference is now made to the following descriptions taken in conjunction with the accompanying drawings, in which:

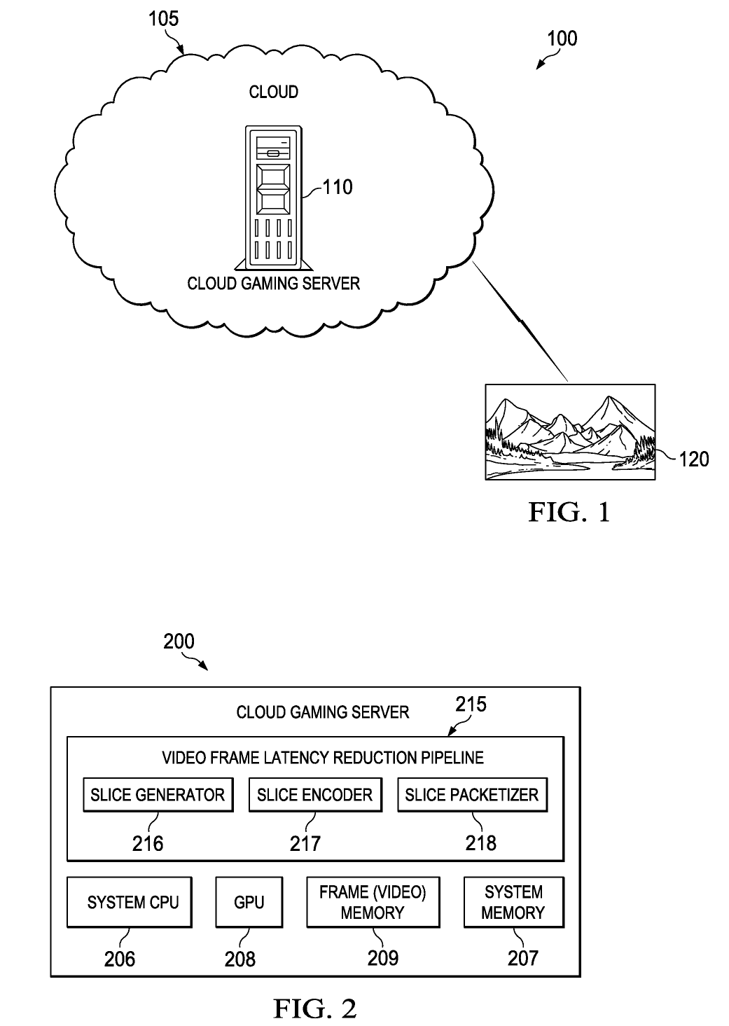

FIG. 1 illustrates a diagram of an embodiment of a cloud gaming system constructed according to the principles of the present disclosure;

FIG. 2 illustrates a block diagram of a cloud gaming server as may be employed in the cloud gaming system of FIG. 1;

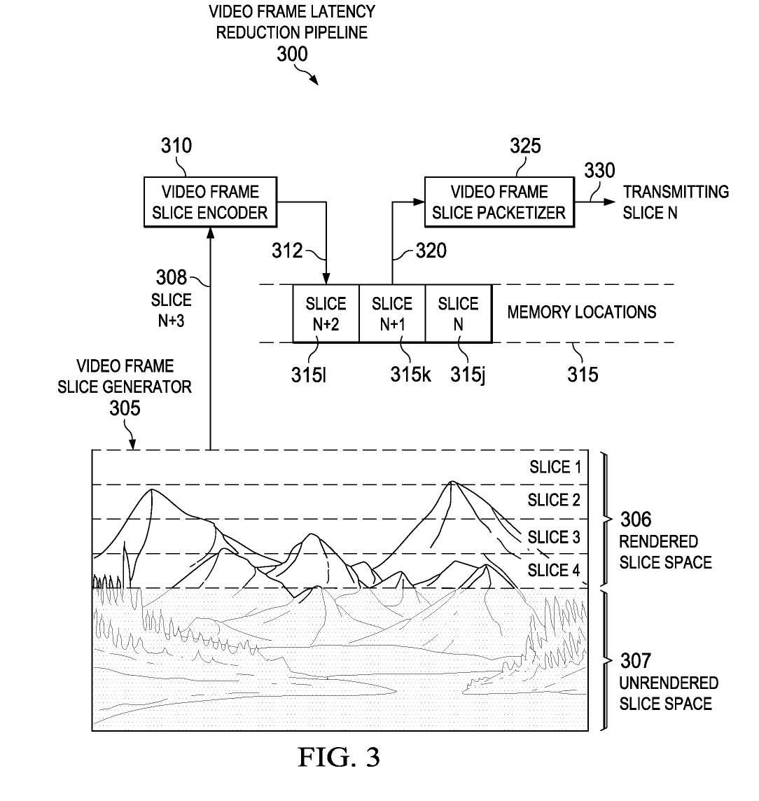

FIG. 3 illustrates a more detailed diagram of an embodiment of a video frame latency reduction pipeline constructed according to the principles of the present disclosure;

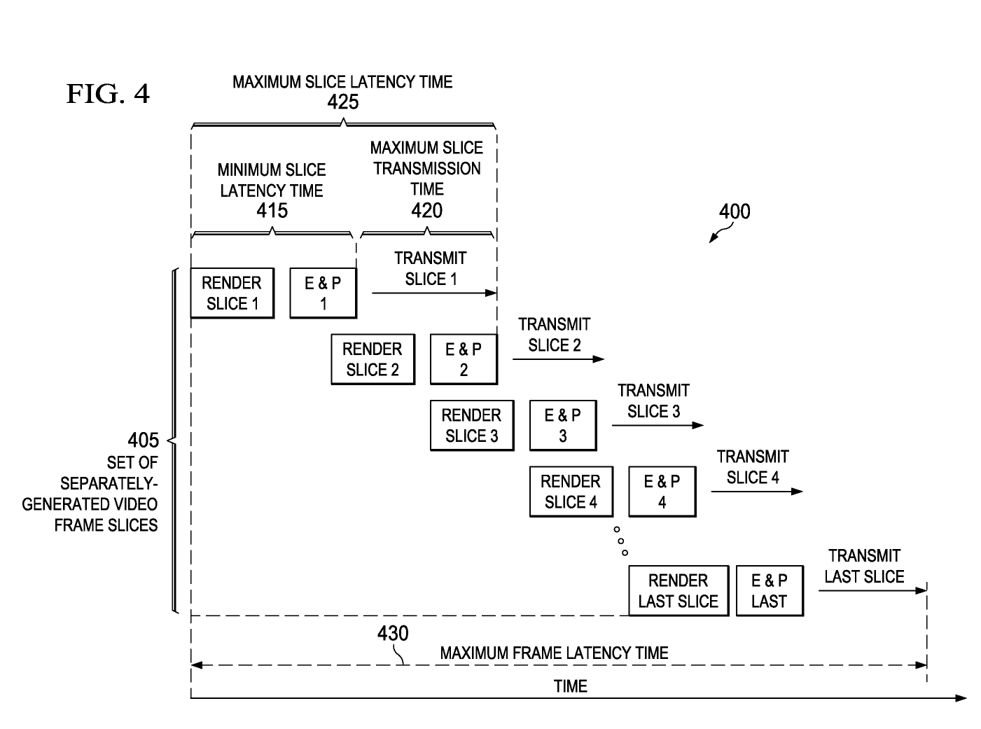

FIG. 4 illustrates an embodiment of a video frame slice timing diagram for a set of separately-generated video frame slices corresponding to a video frame latency reduction pipeline such as the one discussed with respect to FIG. 3;

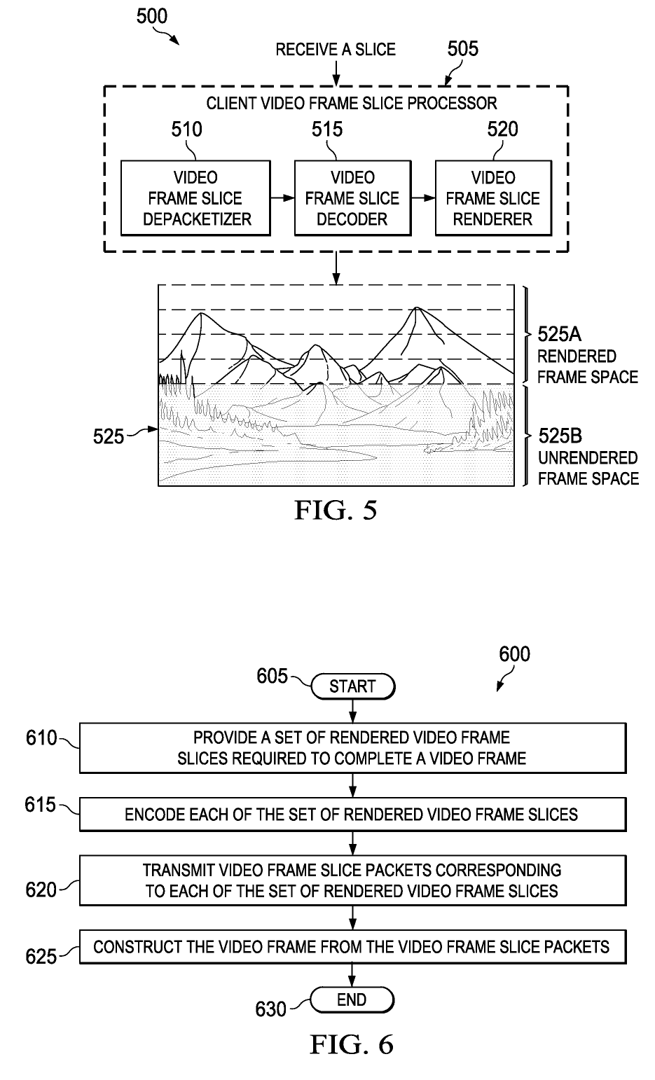

FIG. 5 illustrates a portion of a cloud gaming device client constructed according to the principles of the present disclosure; and

FIG. 6 illustrates a flow diagram of an embodiment of a video frame latency reduction method carried out according to the principles of the present disclosure.

### DETAILED DESCRIPTION

Embodiments of the present disclosure mitigate undesirable video frame latencies by generating, encoding and transmitting multiple video frame slices in a cloud gaming environment corresponding to a rendered video frame for a gaming device. The video frame is encoded employing multiple slices, wherein a cloud gaming server reads back an encoded bitstream for each completed slice and transmission of the completed slice begins at completion of its pipeline processing instead of waiting until full video frame encoding is completed. This action reduces latency in the encoding stage and also enhances packet transmissions so that packet loss can be reduced due to lower packet burst transmission bandwidth requirements.

FIG. 1 illustrates a diagram of an embodiment of a cloud gaming system, generally designated 100, constructed according to the principles of the present disclosure. The cloud gaming system 100 includes a cloud network 105, a cloud gaming server 110 and a gaming device 120. The cloud network 105 connects rendering and playing actions of a game between the cloud gaming server 110 and the gaming device 120. Of course, other embodiments of the cloud gaming system 100 may employ gaming environments having multiple cloud gaming servers or more than one gaming device.

The cloud gaming server 110 provides rendering of video frames for a game that is being played on the gaming device 120. A video frame latency reduction pipeline is coupled to the cloud gaming server 110 and provides a set of separately-generated video frame slices that render each video frame. The cloud network 105 transmits these video frame slices to the gaming device 120, which operates as a cloud gaming client that processes each of the set of separately-generated video frame slices to construct the video frame. A video frame slice is defined as a spatially distinct region of a video frame that is encoded separately from any other region in the video frame.

Generally, the cloud network 105 may employ data paths that are wireless, wired or a combination of the two. Wireless data paths may include Wi-Fi networks or cell phone networks, for example. Examples of wired data paths may include public or private wired networks that are employed for data transmission. Of course, the Internet provides an example of a combination of both wireless and wired networks.

The cloud gaming server 110 maintains specific data about a game world environment being played as well as data corresponding to the gaming device 120. In the illustrated embodiment, the cloud gaming server 110 provides a cloud gaming environment wherein general and specific processors employing associated general and specific memories are used. The operating system in the cloud gaming server 110 senses when the gaming device 120 connects to it through the cloud network 105 and starts a game or includes it in a game that is rendered primarily or completely on a graphics processor. This display rendering information is then encoded as a compressed video stream and sent through the cloud network 105 to the gaming device 120 for display.

Typically, the gaming device 120 is a thin client that depends heavily on the cloud gaming server 110 to assist in or fulfill its traditional roles. The thin client may employ a computer having limited capabilities (compared to a standalone computer) and one that accommodates only a reduced set of essential applications. Typically, the gaming device 120 as a thin client is devoid of optical drives (CD-ROM or DVD drives), for example. In the illustrated example of the cloud gaming system 100, the gaming device 120 may employ thin client devices such as a computer tablet or a cell phone having touch sensitive screens, which are employed to provide user-initiated interactive or control commands. Other applicable thin clients may include television sets, cable TV control boxes or netbooks, for example. Of course, other embodiments may employ standalone computers systems (i.e., thick clients) although they are generally not required.

FIG. 2 illustrates a block diagram of a cloud gaming server, generally designated 200, as may be employed in the cloud gaming system 100 of FIG. 1. The cloud gaming server 200 provides a general purpose computing capability that also generates needed display rendering information. The cloud gaming server 200 includes a system central processing unit (CPU) 206, a system memory 207, a graphics processing unit (GPU) 208 and a frame memory 209.

The system CPU 206 is coupled to the system memory 207 and the GPU 208 and provides general computing processes and control of operations for the cloud gaming server 200. The system memory 207 includes long term memory storage (e.g., a hard drive or flash drive) for computer applications and random access memory (RAM) to facilitate computation by the system CPU 206. The GPU 208 is further coupled to the frame memory 209 and provides monitor display and frame control for a gaming device such as the gaming device 120 of FIG. 1.

The cloud gaming server 200 also includes a video frame latency reduction pipeline 215 having a slice generator 216, a slice encoder 217 and a slice packetizer 218. The slice generator 216 provides a set of separately-generated video frame slices required for a video frame. The slice encoder 217 encodes each of the set of separately-generated video frame slices into corresponding separately-encoded video frame slices required for the video frame. Additionally, the slice packetizer 218 further packages each of the separately-encoded video frame slices into corresponding transmission packets.

The video frame latency reduction pipeline 215 is generally indicated in the cloud gaming server 200, and in one embodiment, it is a software module that provides operation direction to the other computer components discussed above. Alternately, the video frame latency reduction pipeline 215 may be implemented as a hardware unit, which is specifically tailored to enhance computational throughput speeds for the video frame latency reduction pipeline 215. Of course, a combination of these two approaches may be employed.

FIG. 3 illustrates a more detailed diagram of an embodiment of a video frame latency reduction pipeline, generally designated 300, constructed according to the principles of the present disclosure. The video frame latency reduction pipeline 300 includes a video frame representation of a video frame slice generator 305, a video frame slice encoder 310, video frame slice memory 315 and a video frame slice packetizer 320. The video frame slice generator 305 is referenced to a gaming device display and indicates one embodiment of how a set of video frame slices may be generated.

In the illustrated embodiment, the video frame latency reduction pipeline 300 accommodates a span of four video frame slices. The following operational discussion for the video frame latency reduction pipeline 300 is presented for a general case, wherein a video frame slice N is provided from a packetizer output 330 for transmission. A video frame slice N+1 is provided from a memory location 315, through a packetizer input 320 to be packetized by the video frame slice packetizer 325. A video frame slice N+2 is provided for storage into a memory location 315_{L}, by an encoder output 312. And, a video frame slice N+3 is provided from the video frame slice generator 305 through an encoder input 308 to be encoded by the video frame slice encoder 310.

In FIG. 3, the video frame slice generator 305 is shown to be generating contiguous video frame slices of about the same slice area. Generally, the video frame slices do not have to be the same area nor do they have to be contiguous. The number of slices in the set of separately-generated video frame slices may typically depend on a pixel density of the video frame where each slice may approximately correspond to a same number of contained pixels. In certain situations, the first or several successive video frame slices may be chosen to have smaller than average slice areas in order to minimize initial slice latency times. Correspondingly, this concept may be extended to the entire set of video frame slices to accommodate a latency reduction requirement for the video frame.

Alternately, the number of video frame slices in the set or their individual slice sizes may depend on a network transmission bandwidth constraint for the video frame. A slice area may increase or decrease for at least a portion of the set of separately-generated video slices when a quantity or degree of pixel change from a previous video frame is respectively less than or greater than a predetermined value. Additionally, slice area or number of video frame slices in the set may be determined by a density of the pixels changing.

FIG. 4 illustrates an embodiment of a video frame slice timing diagram for a set of separately-generated video frame slices, generally designated 400, corresponding to a video frame latency reduction pipeline such as the one discussed with respect to FIG. 3. The video frame slice timing diagram 400 indicates a set of separately-generated (i.e., separately rendered) video frame slices 405, wherein each slice of the set has its own separate corresponding encode and packetize time (E&P1, E&P2, etc.) as well as a slice transmit time (TRANSMIT SLICE 1, TRANSMIT SLICE 2, etc.). Here, each slice of the set of separately-rendered video frame slices 405 is serially generated as may be provided by a single video frame slice generation operation. Other embodiments may allow a more parallel generation of a set of separately-rendered video frame slices.

The video frame slice timing diagram 400 indicates that each separate encode and packetize time begins shortly after a corresponding completion of slice rendering thereby indicating that the memory buffering time of the slice is small. Other embodiments or situations may require more memory buffering time. A minimum slice latency time 415 is shown indicating a latency time required to provide a rendered, encoded and packetized slice before its transmission. In this example, a maximum slice transmission time 420 is indicated between the completion times of adjacently rendered, encoded and packetized slices. A maximum slice latency time 425 is indicated for these conditions resulting in a maximum frame latency time 430, as shown.

The maximum slice latency time 425 is an initial time delay corresponding to a partially rendered video frame (i.e., the first video frame slice) arriving at a user device (such as the gaming device 120 of FIG. 1) for processing and display. Then, the maximum frame latency time 430 is a total time delay corresponding to when a last video frame slice of the partially rendered video frame arrives for processing and display to provide a completed frame. Of course, the maximum slice latency time 425 is substantially smaller than the maximum frame latency time 430.

Therefore, the pipelining of video frame slices allows embodiments of the present disclosure to provide frame rendering at the user device that greatly reduces response times for initial frame activation. Additionally, this pipelining often provides a more enhanced user experience, since a rendered display is “painted” slice by slice on the user device instead of just appearing after a noticeable delay. User device processing and display are discussed with respect to FIG. 5 below.

FIG. 5 illustrates a portion of a cloud gaming device client, generally designated 500, constructed according to the principles of the present disclosure. The cloud gaming portion 500 includes an embodiment of a client video frame slice processor 505 and a client video display 525 that illustrate a transmission received from a video frame latency reduction pipeline such as the video frame latency reduction pipeline 500 of FIG. 3. Generally, the client video frame slice processor 505 includes a video frame slice depacketizer 510, a video frame slice decoder 515 and a video frame slice renderer 520. The video frame slice depacketizer 510 depacketizes each video frame slice transmission as it is received. The video frame slice decoder 515 decompresses the received video frame slice, and the video frame slice renderer 520 provides the decompressed and rendered video frame slice for display to the client video display 525.

In the illustrated embodiment, the client video frame slice processor 505 has provided a first portion of a set of separately-processed video frame slices. The client video display 525 indicates this in a rendered frame space 525A. An unrendered frame space 525B will be used to display the remaining video frame slices as they are received. The first portion of video frame slices are seen to be contiguous in the rendered frame space 525A and were generated in adjacent or contiguous time periods to provide a finished portion of the video frame, as indicated in FIG. 5. Alternately, the first portion of the video frame slices is not required employ contiguous video frame slices, and each video frame slice may be rendered in any available time period. Additionally, the client video frame slice processor 505 provides an additional display latency (i.e., processing delay) for the video frame transmission. However, this latency may typically be designed to be much smaller than a maximum frame latency time.

FIG. 6 illustrates a flow diagram of an embodiment of a video frame latency reduction method, generally designated 600, carried out according to the principles of the present disclosure. The method 600 starts in a step 605, and a set of rendered video frame slices required to complete a video frame is provided, in a step 610. Then, in a step 615, each of the set of rendered video frame slices is encoded. Video frame slice packets corresponding to each of the set of rendered video frame slices are transmitted in a step 620. The video frame is constructed from the video frame slice packets in a step 625. In some embodiments, slice buffering is provided between the encoding of step 615 and the transmitting of step 620.

In one embodiment, providing the set of rendered video frame slices correspondingly provides them in a set of slice time periods required to complete the video frame. In another embodiment, encoding each of the set of rendered video frame slices provides video compression to each of the set of rendered video frame slices. In yet another embodiment, a slice area of at least a portion of the set of rendered video frame slice increases when a quantity of pixels changing from a previous video frame is less than a predetermined value. Correspondingly, a slice area of at least a portion of the set of rendered video frame slice decreases when a quantity of pixels changing from a previous video frame is greater than a predetermined value. In still another embodiment, a slice area of at least a portion of the set of rendered video frame slices is dependent on at least one selected from the group consisting of a pixel density of the video frame, a latency reduction requirement and a network transmission bandwidth constraint. The method 600 ends in a step 630.

While the method disclosed herein has been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

Those skilled in the art to which this application relates will appreciate that other and further additions, deletions, substitutions and modifications may be made to the described embodiments.

What is claimed is:

1. A video frame latency reduction pipeline, comprising:
a slice generator configured to provide a rendered video frame slice required for a video frame;
a slice encoder configured to encode the rendered video frame slice of the video frame; and
a slice packetizer configured to package the encoded and rendered video frame slice into packets for transmission.

2. The pipeline as recited in claim 1 wherein the rendered video frame slice is one of a set of rendered video frame slices required to complete the video frame.

3. The pipeline as recited in claim 1 wherein the rendered video frame slice is provided in one of a set of slice time periods required to complete the video frame.

4. The pipeline as recited in claim 1 wherein the slice encoder provides video compression to encode the rendered video frame slice.

5. The pipeline as recited in claim 1 wherein a slice area of the rendered video frame slice increases or decreases when a quantity of pixels changing from a previous video frame is respectively less than or greater than a predetermined value.

6. The pipeline as recited in claim 1 wherein a slice area of the rendered video frame slice is dependent on at least one selected from the group consisting of:
a pixel density of the video frame;
a latency reduction requirement; and
a network transmission bandwidth constraint.

7. The pipeline as recited in claim 1 further comprising a slice memory that provides slice buffering between the slice encoder and the slice packetizer.

8. A video frame latency reduction method, comprising:
providing a set of rendered video frame slices required to complete a video frame;
encoding each of the set of rendered video frame slices;
transmitting video frame slice packets corresponding to each of the set of rendered video frame slices; and
constructing the video frame from the video frame slice packets.

9. The method as recited in claim 8 wherein providing the set of rendered video frame slices correspondingly provides them in a set of slice time periods required to complete the video frame.

10. The method as recited in claim 8 wherein encoding each of the set of rendered video frame slices provides video compression to each of the set of rendered video frame slices.

11. The method as recited in claim 8 wherein a slice area of at least a portion of the set of rendered video frame slices increases when a quantity of pixels changing from a previous video frame is less than a predetermined value.

12. The method as recited in claim 8 wherein a slice area of at least a portion of the set of rendered video frame slices decreases when a quantity of pixels changing from a previous video frame is greater than a predetermined value.

13. The method as recited in claim 8 wherein a slice area of at least a portion of the set of rendered video frame slices is dependent on at least one selected from the group consisting of:
a pixel density of the video frame;
a latency reduction requirement; and
a network transmission bandwidth constraint.

14. The method as recited in claim 8 further comprising providing slice buffering between the encoding and the transmitting.

15. A cloud gaming system, comprising:
a cloud gaming server that provides rendering for a video frame employed in cloud gaming;
a video frame latency reduction pipeline coupled to the cloud gaming server, including:
a slice generator that provides a set of separately-rendered video frame slices required for a video frame,
an slice encoder that encodes each of the set of separately-rendered video frame slices into corresponding separately-encoded video frame slices of the video frame, and
a slice packetizer that packages each separately-encoded video frame slice into slice transmission packets;
a cloud network that transmits the slice transmission packets; and
a cloud gaming client that processes the slice transmission packets to construct the video frame.

16. The system as recited in claim 15 wherein each of the set of separately-rendered video frame slices is provided in one of a corresponding set of slice time periods required to complete the video frame.

17. The system as recited in claim 15 wherein the slice encoder provides video compression to encode each of the set of separately-rendered video frame slices.

18. The system as recited in claim 15 wherein a slice area of at least a portion of the set of separately-rendered video frame slices increases or decreases, respectively, when a quantity of pixels changing from a previous video frame is less than or greater than a predetermined value.

19. The system as recited in claim 15 wherein a slice area of at least a portion of the set of rendered video frame slice is dependent on at least one selected from the group consisting of:
a pixel density of the video frame;
a latency reduction requirement; and
a network transmission bandwidth constraint.

20. The system as recited in claim 15 further comprising a slice memory that provides slice buffering between the slice encoder and the slice packetizer.
